(19) United States
(12) Patent Application Publication
(10) Pub. No.: US 2026/0158999 A1
(43) Pub. Date: Jun. 11, 2026

(54) STEP AND COMPLIANT MEMBER FOR A VEHICLE

(71) Applicant: FCA US LLC, Auburn Hills, MI (US)

(72) Inventors: Fabian Heinz Dieter Krissel, Russelsheim am Main (DE); Mark J. Skynar, Auburn Hills, MI (US); Arturo Guzman-Magana, Auburn Hills, MI (US)

(21) Appl. No.: 18/975,058

(22) Filed: Dec. 10, 2024

(51) Int. Cl. B60R 3/00

(52) U.S. Cl. CPC B60R 3/002

(57) ABSTRACT

A vehicle may have side steps mounted to the sides of the vehicle. Each side step has an outer side that spans between the front end and the rear end and an inner side adapted to be coupled to or adjacent to a vehicle body, the inner side located opposite to the outer side, the side step has a top side and a bottom side opposite to the top side and in assembly on the vehicle arranged facing a road surface. A compliant member has a connection feature by which the compliant member is connected to the bottom side of the side step along the inner side of the side step, wherein the compliant member has a greater flexibility than the side step to permit flexing of the compliant member relative to the side step.

### FIELD

The present disclosure relates to a step assembly and a compliant member to be mounted on a vehicle.

### BACKGROUND

Vehicles with unibody designs may have a single panel spanning the length and width of the vehicle to minimize turbulent airflow and to seal the vehicle from the environment. However, vehicles with body on frame designs may experience flex and torsion between the body and the frame during operation of the vehicle. Therefore, a panel spanning between body and frame could break during operation of the vehicle.

### SUMMARY

In at least some implementations, a side step for a vehicle has a front end and a rear end with the front end adapted to be arranged closer to a front of a vehicle than the rear end. The side step has an outer side that spans between the front end and the rear end and an inner side adapted to be coupled to or adjacent to a vehicle body, the inner side located opposite to the outer side, the side step has a top side and a bottom side opposite to the top side and in assembly on the vehicle arranged facing a road surface. A compliant member having a first side connected to and extending along the inner side of the side step, an outer side opposite to the inner side, and a connection feature by which the compliant member is connected to the bottom side of the side step along the inner side of the side step. The compliant member has a greater flexibility than the side step to permit flexing of the compliant member relative to the side step.

In at least some implementations, the side step includes a main body, and a bottom cover coupled to the main body, the main body includes the top side and outer side of the side step and the bottom cover includes the bottom side of the side step, and wherein the compliant member is coupled to the bottom cover.

In at least some implementations, the bottom side and the compliant member are joined by a tongue and groove connection.

In at least some implementations, one of the side step and the compliant member includes one or more tongues and the other of the side step and the compliant member includes one or more slots in which the one more tongues are received.

In at least some implementations, the one or more tongues and the one or more grooves extend parallel to the inner side of the side step.

In at least some implementations, the compliant member extends along the length of the inner side between the front end and the rear end of the side step without a gap between the compliant member and the inner side of the side step.

In at least some implementations, a bottom side of the compliant member is at or within 2.5 mm of the same vertical height as the inner side of the side step.

In at least some implementations, the bottom side and the compliant member are overlapped and joined together in a region of overlap.

In at least some implementations, a vehicle includes a frame, a vehicle body coupled to the frame, the body defining a first wheel well and a second wheel well spaced from the first wheel well. The vehicle may also include a side step coupled to the vehicle body, the side step has an inner side, an outer side opposite to the inner side, a top side, a bottom side opposite to the top side and in assembly on the vehicle arranged facing a ground surface, a front end adjacent to the first wheel well and a rear end adjacent to the second wheel well, and the front end is adapted to be arranged closer to a front of a vehicle than the rear end. An under-vehicle panel may be coupled to an underside of the frame, the panel having a first side, a second side opposite to the first side, a rear side and a front side closer to the front of the vehicle than the rear side. A compliant member may have a first side connected to and extending along the inner side of the side step, an outer side opposite to the inner side and overlapped with the first side of the panel, wherein the compliant member has a greater flexibility than the side step to permit flexing of the compliant member relative to the side step and the frame, and the compliant member spans a gap between the side step and the first side of the panel.

In at least some implementations, the side step extends between the first wheel well and the second wheel well.

In at least some implementations, the side step includes a main body, and a bottom cover coupled to the main body, the main body includes the top side and outer side of the side step and the bottom cover includes the bottom side of the side step, and wherein the compliant member is coupled to the bottom cover.

In at least some implementations, the bottom side of the side step and the compliant member are joined by a tongue and groove connection.

In at least some implementations, one of the side step and the compliant member includes one or more tongues and the other of the side step and the compliant member includes one or more slots in which the one more tongues are received.

In at least some implementations, the one or more tongues and the one or more grooves extend parallel to the inner side of the side step.

In at least some implementations, the compliant member extends along the length of the inner side between the front end and the rear end of the side step without a gap between the compliant member and the inner side of the side step.

In at least some implementations, a bottom side of the compliant member is at or within 2.5 mm of the same vertical height as the inner side of the side step.

In at least some implementations, the bottom side and the compliant member are overlapped and joined together in a region of overlap.

In at least some implementations, the bottom side of the side step extends between the first wheel well and the second wheel well and the bottom side is continuous with the outer side, and inner side, the first wheel well, and the second wheel well.

In at least some implementations, the bottom side is continuous with the compliant member and the under-vehicle panel.

In at least some implementations, the bottom side is continuous with the outer side and the inner side.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 shows a perspective view of a vehicle with a step assembly;

FIG. 2 shows an underside of the vehicle with the step assembly;

FIG. 3 shows a perspective view of part of the underside of the vehicle with the step assembly;

FIG. 4 shows a cross-sectional view of the step assembly through section line 4-4 of FIG. 3; and

FIG. 5 is a detailed view of the area within the rectangle 5 in FIG. 4.

### DETAILED DESCRIPTION

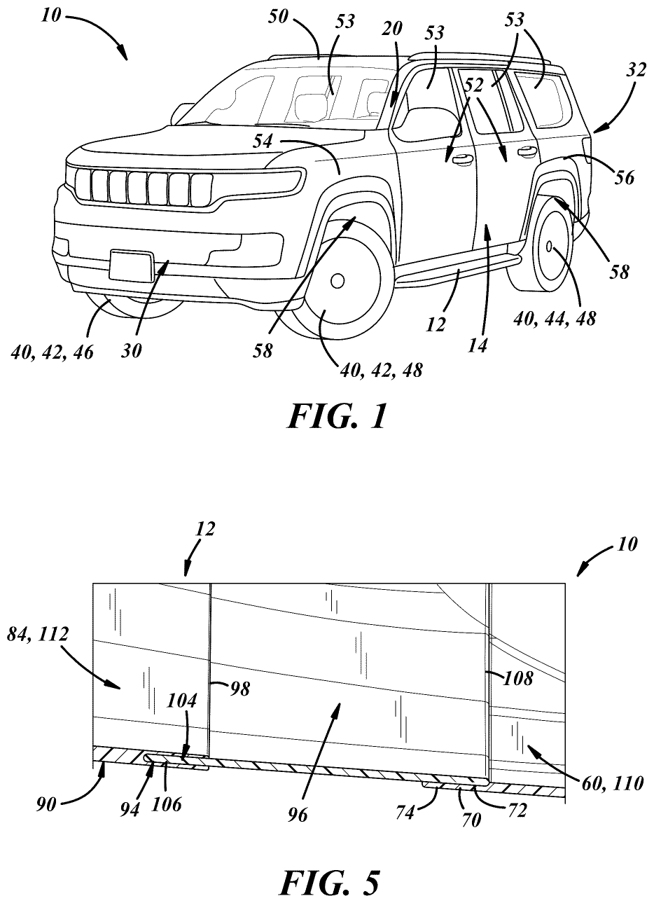

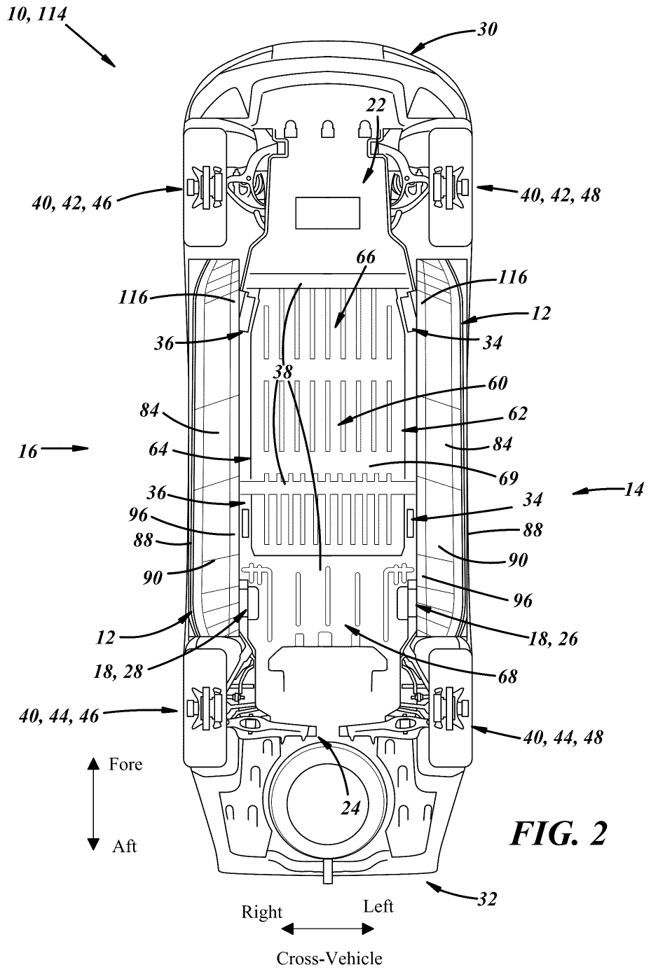

Referring in more detail to the drawings, FIGS. 1 and 2 show a vehicle 10 with two side steps 12 that extend along left and right sides 14, 16 of the vehicle 10 (only the left side 14 is pictured in FIG. 1). The vehicle 10 has a frame 18 to support a vehicle body 20 and, as shown in FIG. 2, the frame 18 has a front side 22, a rear side 24, a left side 26, and a right side 28 corresponding to a front side 30, a rear side 32, a left side 14, and a right side 16 of the vehicle 10. On the left and right sides 26, 28 of the frame 18, a left side rail 34 and a right side rail 36 extend from the front of the vehicle 30 to the rear of the vehicle 32 in a fore-aft direction. The left side rail 34 and the right side rail 36 are spaced apart in a cross-vehicle or cross-car direction (e.g. left to right, and where cross-car is not limited to coupes or sedans and may include SUVs, trucks and other vehicles) by cross members 38 and both the side rails 34, 36 and the cross members 38 may be configured to support portions of the vehicle 10. The frame 18, typically made of heavy-duty steel or aluminum, supports mechanical components like the powertrain, suspension, and drivetrain.

The frame 10 is elevated in a vertical direction from a road surface by wheels 40 mounted to the frame 18 by suspension and drivetrain components of the vehicle 10. The vertical direction is parallel to the direction of the force of gravity, and perpendicular to the fore-aft and cross-car directions. The vehicle 10 has four wheels 40 in total; one front wheel 42 on both the right and left sides of the vehicle 10 and one rear wheel 44 on both the left and right sides 14, 16 of the vehicle 10. The front wheels 42 and the rear wheels 44 are spaced apart from the front side 30 to the rear side 32 of the vehicle 10 in the fore-aft direction and the right wheels 46 and the left wheels 48 are spaced apart in the cross-car direction. However, in some implementations, it is possible for the vehicle 10 to have a different quantity of wheels 40 that may be arranged in a different orientation than as shown in FIGS. 1-2.

The body 20 of the vehicle 10, shown best by FIG. 1, may include components like a roof 50, doors 52, windows 53, fenders 54 (which may be part of front and rear fascias or body modules), and quarter panels 56, and may be made from materials such as stamped steel, aluminum, polymers or composites. The body 20 is attached to the frame 18 at various mounting points and extends beyond the frame 18 both in the fore-aft direction and the cross-car direction. The body 20 defines a passenger compartment including seats, a dashboard, and other interior components. The wheels 40 may be at least partially received in respective wheel wells 58 to reduce drag near the wheels 40 when the vehicle 10 is in motion and to seal the passenger compartment from wind, water, and road noise.

An under-vehicle panel 60 may be attached to the frame 18 at one or more points beneath the frame 18 and body 20 of the vehicle 10. The under-vehicle panel 60 may be a panel that has a solid body and, in some implementations, may not have holes or perforations beyond what is used to mount the under-vehicle panel 60 to the frame 18. A polymeric or metallic material may be used for the under-vehicle panel 60. The under-vehicle panel 60 may have a width in the cross-car direction defined between opposite left and right sides 62, 64, a length in the fore-aft direction defined between a front side 66 and a back side 68, and a thickness in the vertical direction between planar or generally planar inner and outer surfaces 67, 69. The under-vehicle panel 60 may be fastened to the side rails 34, 36 of the frame 18 along the periphery of the under-vehicle panel 60 and/or to one or more cross-members 38 of the frame 18 either directly to the frame 18 or to brackets that are fixed to the frame 18. In some implementations, the under-vehicle panel 60 may be multiple sections or panels configured to fit together and cover a portion of the bottom of the frame 18 of the vehicle 10. By covering the underside 114 of the vehicle 10, the under-vehicle panel 60 may reduce turbulent air flow to increase aerodynamic efficiency, protect vehicles components from debris, and provide a water-tight or water-resistant seal for vehicle components. The under-vehicle panel 60 may have flanges 70 extending beyond the side rails 34, 36 and spanning in the fore-aft direction along the left and right sides 62,64 of the under-vehicle panel 60. Each flange 70 has a thickness that extends from a top surface 72 of the flange 70 to a bottom surface 74 of the flange 70 which may be aligned and continuous with or part of the outer surface 69 of the under-vehicle panel 60.

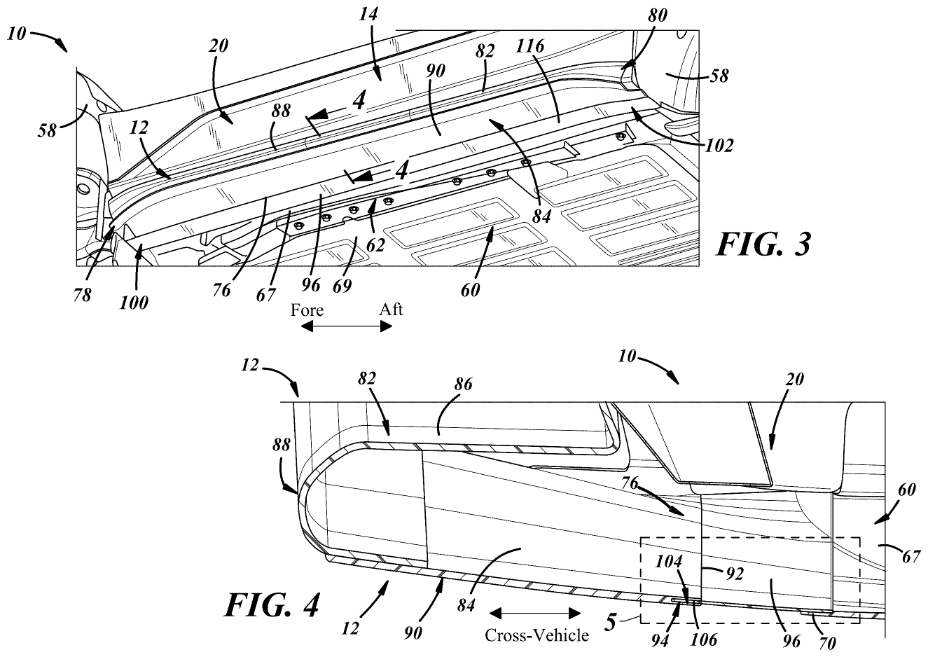

As shown in FIGS. 2-5, each side step 12 extends between the wheel wells 58 of the respective side of the vehicle. The side step 12 has an inner side 76 fastened to the vehicle body 20 with a front end 78 and a rear end 80. The front end 78 is closer to the front 30 of the vehicle 10 than the rear end 80 and the rear end 80 is closer to the rear 32 of the vehicle 10 than the front end 78. The side step 12 may be defined by one or more than one component. In the example shown, the side step 12 includes a main body 82 and a bottom cover 84 that is connected to the main body 82. A metal inlay panel (not shown) may provide structural support and/or a decorative finish to the side step 12. The inlay panel may be carried by (e.g. fixed to) the main body 82 that extends between the wheel wells 58 of the body 20 to cover a top side 86, an outer side 88, and part of a bottom side 90 of the side step 12.

The bottom cover 84 extends along most or all of the fore-aft length of the side step 12, and the bottom cover 84 is fastened to the main body 82 by one or more fasteners, an adhesive, a weld or other bond, or a combination of one or more fasteners and bond(s). The bottom cover 84 of each side step 12 may extend in the cross-car direction from an area of overlap and connection to the main body 82 at or adjacent to the outer side 88 to an inner surface 92 spaced from the main body 82 and closer to a respective one of the side rails 34, 36. In some implementations, as shown by FIGS. 4-5, a groove 94 is provided in the inner surface 92 of each bottom cover 84 and may span all or part of the length of the side step 12 in the fore-aft direction. The groove 94 may be continuous along its length, or it may be defined by separate, spaced apart grooves, and the groove has a depth extending into the inner surface 92 of the bottom cover 84 a desired distance.

To provide a flexible connection of the side step 12 to the under-vehicle panel 60, a compliant member 96 may be provided for each side step 12. The compliant member 96 may have a first or outer side surface 98 that spans all or part of the fore-aft length of the inner surface 92 of the bottom cover 84, and all or part of a length of the compliant member 96 between a front end 100 and a rear end 102 of the compliant member 96. The compliant member 96 may have a connection feature 104, such as but not limited to, a tongue 106 or flange along the outer side that is constructed to be received within the groove 94 of the bottom cover 84 to connect the compliant member 96 to the side step 12. The tongue 106 may be coextensive in length with the groove 94 or grooves, or of a different length, as desired, and may fill all or some or part of the groove 94 or grooves in the bottom cover, to connect the compliant member 96 to the side step 12. The tongue 106 and the groove 94 may be fixed to each other with a friction fit, fasteners, adhesive, weld or other bond, or a combination of two or more of these. However, it is possible to attach the compliant member 96 to the side step 12 other than by the tongue and groove connection. For example, the connection 104 may be a simple overlap, dovetail joint, butt joint, or other connection arrangement.

The compliant member 96 may be positioned between the under-vehicle panel 60 and the side step 12, extend inward from the side step 12 and outward from the under-vehicle panel 60, to span and close a gap between the under-vehicle panel 60 and the side step 12. In at least some implementations, the flange 70 of the under-vehicle panel 60 may overlap part of the compliant member 96, including all or part of a second or inner side 108 of the compliant member 96 that may span the length of the compliant member 96 between the front end 100 and the rear end 102. The compliant member 96 may be fixed to the flange 70 of the under-vehicle panel 60 by fasteners, adhesive, weld or other bond, or a combination of fasteners and bond(s).

The compliant member 96 may be composed of a polymeric material or a blend of materials. In at least some implementations, the compliant member 96 is formed from a two-shot elastomeric construction, which may be a blend of two polymeric materials that when combined and molded may be optimized for both strength and flexibility. In at least some implementations, the compliant member 96 is formed from a material different than the materials used for the side step 12 (e.g. both the main body 82 and bottom cover 84), and the material or materials of the compliant member 96 have a greater flexibility and less hardness than that of the side step 12.

Vehicles with a separate body and frame (e.g. a body on frame construction) may have some advantages compared to vehicles of unibody construction, such as greater durability and increased towing capacity, particularly in trucks and SUVs. However, due to vibrations, flex, and torsional movement between the body and the frame, it is not desirable to directly connect together one panel that is connected to the body with another panel that is connected to the frame, or to couple one panel to both the body and frame as movement between the body and frame can crack or break the panel(s). Due to this, on vehicles of body on frame construction, one or more gaps may be present between the frame and the body or between panels covering the frame and body. The gaps can create turbulent air pockets under the vehicle, and prevent a complete seal of the underside of the vehicle from environmental conditions.

As described herein, the compliant member 96 can be positioned between a first under-vehicle panel 110 coupled to the frame 18 and a second under-vehicle panel 112 connected to the body 20 in a body on frame vehicle structural assembly. In the example shown, the under-vehicle panels 110, 112 include the under-vehicle panel 60 and the side step 12, and the compliant member 96 permits the underside 114 of the vehicle 10 including the bottom 90 of the side step 12, to be more and up to completely covered, that is, without significant gaps between adjacent panels. This improves aerodynamic efficiency and better protects the underside 114 of the vehicle 10 from the environment while permitting relative movement between the frame 18 and the body 20, without damage to the side step 12 or the under-vehicle panel 60. That is, when the frame 18 and the body 20 flex relative to each other, the compliant member 96 may flex while maintaining contact with both the side step 12 and the under-vehicle panel 60, preventing damage to the side step 12, the body 20, and the under-vehicle panel 60 of the vehicle 10.

In at least some implementations, the compliant member 96 spans at least a majority of and up to the full length of the inner side 76 of the side step 12, and the compliant member 96 is continuous along its length. In this way, the compliant member 96 extends the distance between the wheel wells 58 and gaps greater than 5 mm are not present between the compliant member 96 and the surfaces defining the portions of the wheel well 58 that are closest to the side step 12 and the compliant member 96. Additionally, the compliant member 96 is coupled to or overlaps the under-vehicle panel 60 along at least a majority of and up to the entire inner side 108 of the compliant member 96. In at least some implementations, a bottom side 116 of the compliant member 96 is aligned with or mostly aligned with and continuous with the bottom 90 of the side step 12 at the inner side 92 of the bottom cover 84, and with the outer side 69 of the under-vehicle panel 60. In at least some implementations, the difference in height between the bottom side 116 of the compliant member 96 and the bottom side 90 of the side step 12 at the inner side 92 of the side step 12 is less than 2.5 mm along the length of the compliant member 96. Similarly, in at least some implementations, the difference in height between the bottom side 116 of the compliant member 96 and the outer side 69 of the under-vehicle panel 60 is less than 2 mm along the length of the compliant member 96.

What is claimed is:

1. A side step for a vehicle, comprising:
a side step having a front end and a rear end with the front end adapted to be arranged closer to a front of a vehicle than the rear end, the side step has an outer side that spans between the front end and the rear end and an inner side adapted to be coupled to or adjacent to a vehicle body, the inner side located opposite to the outer side, the side step has a top side and a bottom side opposite to the top side and in assembly on the vehicle arranged facing a road surface; and
a compliant member having a first side connected to and extending along the inner side of the side step, an outer side opposite to the inner side, and a connection feature by which the compliant member is connected to the bottom side of the side step along the inner side of the side step, wherein the compliant member has a greater flexibility than the side step to permit flexing of the compliant member relative to the side step.

2. The side step of claim 1, wherein the side step includes a main body, and a bottom cover coupled to the main body, the main body includes the top side and outer side of the side step and the bottom cover includes the bottom side of the side step, and wherein the compliant member is coupled to the bottom cover.

3. The side step of claim 1, wherein the bottom side and the compliant member are joined by a tongue and groove connection.

4. The side step of claim 3, wherein one of the side step and the compliant member includes one or more tongues and the other of the side step and the compliant member includes one or more slots in which the one more tongues are received.

5. The side step of claim 4, wherein the one or more tongues and the one or more grooves extend parallel to the inner side of the side step.

6. The side step of claim 1, wherein the compliant member extends along the length of the inner side between the front end and the rear end of the side step without a gap between the compliant member and the inner side of the side step.

7. The side step of claim 6, wherein a bottom side of the compliant member is at or within 2.5 mm of the same vertical height as the inner side of the side step.

8. The side step of claim 1, wherein the bottom side and the compliant member are overlapped and joined together in a region of overlap.

9. A vehicle, comprising:
a frame;
a vehicle body coupled to the frame, the body defining a first wheel well and a second wheel well spaced from the first wheel well;
a side step coupled to the vehicle body, the side step has an inner side, an outer side opposite to the inner side, a top side, a bottom side opposite to the top side and in assembly on the vehicle arranged facing a ground surface, a front end adjacent to the first wheel well and a rear end adjacent to the second wheel well, and the front end is adapted to be arranged closer to a front of a vehicle than the rear end;
an under-vehicle panel coupled to an underside of the frame, the panel having a first side, a second side opposite to the first side, a rear side and a front side closer to the front of the vehicle than the rear side;
a compliant member having a first side connected to and extending along the inner side of the side step, an outer side opposite to the inner side and overlapped with the first side of the panel, wherein the compliant member has a greater flexibility than the side step to permit flexing of the compliant member relative to the side step and the frame, and the compliant member spans a gap between the side step and the first side of the panel.

10. The vehicle of claim 9, wherein the side step extends between the first wheel well and the second wheel well.

11. The vehicle of claim 9, wherein the side step includes a main body, and a bottom cover coupled to the main body, the main body includes the top side and outer side of the side step and the bottom cover includes the bottom side of the side step, and wherein the compliant member is coupled to the bottom cover.

12. The vehicle of claim 9, wherein the bottom side of the side step and the compliant member are joined by a tongue and groove connection.

13. The vehicle of claim 12, wherein one of the side step and the compliant member includes one or more tongues and the other of the side step and the compliant member includes one or more slots in which the one more tongues are received.

14. The vehicle of claim 13, wherein the one or more tongues and the one or more grooves extend parallel to the inner side of the side step.

15. The vehicle of claim 9, wherein the compliant member extends along the length of the inner side between the front end and the rear end of the side step without a gap between the compliant member and the inner side of the side step.

16. The vehicle of claim 15, wherein a bottom side of the compliant member is at or within 2.5 mm of the same vertical height as the inner side of the side step.

17. The vehicle of claim 9, wherein the bottom side and the compliant member are overlapped and joined together in a region of overlap.

18. The vehicle of claim 16, wherein the bottom side of the side step extends between the first wheel well and the second wheel well and the bottom side is continuous with the outer side, and inner side, the first wheel well, and the second wheel well.

19. The vehicle of claim 16, wherein the bottom side is continuous with the compliant member and the under-vehicle panel.

20. The vehicle of claim 19, wherein the bottom side is continuous with the outer side and the inner side.
